(19) United States
(12) Patent Application Publication
(10) Pub. No.: US 2004/0093900 A1
(43) Pub. Date: May 20, 2004

(54) Apparatus and method for producing sheets of glass presenting at least one face of very high surface quality

(76) Inventor: Allan M. Fredholm, Hericy (FR)

Correspondence Address: CORNING INCORPORATED, SP-TI-3-1, CORNING, NY, 14831

(21) Appl. No.: 10/696,054

(22) Filed: Oct. 28, 2003

(30) Foreign Application Priority Data
Nov. 15, 2002 (FR) 02-14296

(51) Int. Cl. C03B 17/06

(52) U.S. Cl. 65/25.3; 65/53; 65/44

(57) ABSTRACT

The present invention provides a method of producing sheets of glass having two faces (F₁, F₂), at least one of the faces (F₁) presents high surface quality. Preferably both of the faces (F₁, F₂) present high surface quality. The invention also describes an apparatus suitable for implementing the method for producing the sheets of glass.

### RELATED APPLICATION

This application claims the benefit of priority from French Patent Application No. 02-14296, filed, Nov. 15, 2002, the content of which is incorporated herein by reference.

### FIELD OF INVENTION

The present invention relates to an apparatus and a method for producing sheets of glass. In particular, the sheets of glass have two faces, at least one which presents a high-quality surface.

### BACKGROUND

Over the years, worker in the industry have developed a number of processes for fabricating glass sheets having highly smooth surfaces, such as used in certain computer display or television monitor applications. One such method, the so-called “Fusion Draw” method, has been described in U.S. Pat. Nos. 3,149,949 and 3,338,696, the content of which are incorporated herein by reference. According to the Fusion Draw method, first, two flows of glass are generated by controlled overflow around a so-called “isopipe” of refractory material. (The exact way in which the apparatus acts to ensure that the flow is at a constant rate over the entire width of each of the two flows differs according to the teachings of the two above-identified U.S. patents.) Second, the two flows are kept in contact with the isopipe. And, third, they are reunited at the bottom tip of the isopipe to form a sheet of semisolid glass. The two faces of the sheet of glass, thus, never come in contact with any surface other whatsoever.

The speed of travel of the sheet of glass is generally set with reference to pairs of margin wheels which act on the sheet at its margins. Physical contact, however, damages the margins of the sheets, and subsequently need to be removed. Once the glass sheet has cooled sufficiently to become solid, downstream from the installation, tractor rollers are also generally used on the sheet. The sheet in question is thus kept under tension, and it is stretched to a greater or lesser extent. The thickness of the sheet can thus be set to a desired value. To be noted, incidentally, the margin wheels and/or the tractor rollers also have an effect on the width of the sheet that is produced in this way, by countering the attenuation phenomenon.

For many years, this Fusion Draw method has made it possible to produce sheets of glass presenting exceptional surface quality (both in terms of smoothness, thickness, and flatness or planarity). This method is commonly used to fabricate the sheets required for manufacturing flat screens based on light-emitting diodes (LEDs).

Nevertheless, the Fusion Draw method cannot be used with all typed of glass compositions. The glass flow is controllable only if the flow of glass in contact with the isopipe, and more particularly only if contact with the bottom portion of the isopipe is maintained at a level of viscosity that is sufficiently high. If viscosity is not sufficiently high, then gravity forces dominate over the viscosity forces and it becomes impossible to tension the flow of semisolid glass leaving the bottom tip of the isopipe. The flow of glass is then mechanically unstable and can generate a sheet of glass of very poor quality only (a sheet of glass presenting variations in thickness, distortions, etc.). With reference to this problem of mechanical stability, the person skilled in the art takes the view that in order to be usable in the Fusion Draw method, glass must have viscosity greater than about 20,000 pascal-seconds (Pa.s) (=200,000 poises). Unfortunately, this raises a problem with glasses having viscosity at the liquidus lower than said value. Such glasses, when in contact with the isopipe, run the risk of developing crystals within their mass. Such development of crystals is entirely incompatible with producing glass sheets having the desired quality.

Faced with this technical problem, the Fusion Draw method is unsuitable for producing sheets of excellent quality glass using glasses of low viscosity. Hence, the inventors have devised and developed a method and apparatus of the present invention.

### SUMMARY OF THE INVENTION

The present invention has been devised and developed in the spirit of the standard method in the context of producing sheets of glass presenting high surface quality, which standard method is well known to the person skilled in the art as the “Fusion Draw” method. The present invention has been developed more particularly for enlarging the field of application of said Fusion Draw method to glasses of low viscosity.

In the context of their best implementation and embodiment respectively, said method and apparatus of the invention are suitable for producing sheets of glass presenting high surface quality on both faces. In any event, they are suitable for producing sheets of glass in which at least one of the two faces presents high surface quality.

The present invention, in part, entails a method of producing sheets of glass having two faces (F₁, F₂) with at least one of said faces (F₁) presenting a high surface quality. The method comprises:

a) delivering a stream of glass (1a), said stream of glass (1a) having a first and second face (s₁, S₂), each face is free from making contact with any surface and thus possibly being destabilized mechanically;

b) treating said delivered stream of glass (1a) prior to destabilization by putting a first face (s₂) into contact with a treatment device or mechanism (4a) suitable, temporarily, to support the weight of said glass and for accompanying the falling movement of said glass while increasing glass viscosity and maintaining at least a central strip of said second face (s₁) free from any contact with any surface;

c) using a device or mechanism for controlling glass travel speed (7, 8) to act on the treated stream (1a′) at a suitable distance downstream; and

d) cooling said sheet of glass.

In another aspect, the invention provides an apparatus for producing sheets of glass according to the foregoing method. The apparatus, from upstream to downstream, comprises:

a deliverer (2; 20; 200) for delivering a stream of glass (1a) under conditions in which said stream of glass (1a) has both of its two faces (s₁, S₂) free from any contact with any surface whatsoever;

a treatment device (4a) for treating said delivered stream of glass (1a), said device or mechanism (4a) being suitable for being put into contact with one (S₂) of its two faces (s₁, S₂) and for supporting the weight of said stream (1a) temporarily while accompanying its falling movement and increasing its viscosity and while maintaining at least the central strip of the other one (s₁) of its two faces (s₁, S₂) free from any contact with any surface whatsoever;

the relative disposition of said delivery device or mechanism (2; 20; 200) and said treatment device or mechanism (4a) being compatible with the mechanical stability of said delivered stream (1a);

a controller (7, 8) located at a suitable position downstream for controlling the travel speed, width, and thickness of the resultant sheet of glass; and

a cooler for cooling said sheet of glass that is produced.

### BRIEF DESCRIPTION OF THE FIGURES

The invention in its method and apparatus aspects is described below with reference to the accompanying figures. In the figures, the same references are used to designate the same elements.

FIG. 1 is a section view of apparatus of the invention within which the method of the invention including delivery of a single stream of glass is implemented;

FIG. 2 is a section view of apparatus of the invention within which the method of the invention including the delivery of two streams of glass is implemented;

FIG. 3 is a section view of another apparatus of the invention within which the method of the invention including the delivery of two streams of glass is implemented;

FIG. 4 is a simplified view on IV of the apparatus shown in FIG. 3;

FIGS. 5A and 5B show a device or mechanism for delivering two streams of glass. The device or mechanism is different from those shown in FIG. 3;

FIG. 6 is a section view through the top portion of another apparatus of the invention of the same type as that shown in FIG. 3, this other apparatus includes different devices or mechanisms for delivering the streams of glass;

FIG. 7 is a section view of another apparatus of the invention of the same type as that shown in FIG. 3, but arranged differently;

FIG. 8 is a section view of another apparatus of the invention within which the method of the invention including delivery of two streams of glass is implemented;

FIG. 9 is a simplified view on IX of the apparatus of the invention;

FIG. 10 is a section view of another apparatus of the invention of the same type as that shown in FIGS. 8 and 9; and

FIG. 11 is a section view of another apparatus of the invention of the same type as that shown in FIGS. 3 to 7.

### DETAILED DESCRIPTION OF THE INVENTION

In a first aspect, the present invention provides a method of producing sheets of glass having two faces, at least one of which presents high surface quality, the method being particularly adapted, although not restricted, to performing such production on the basis of low viscosity glasses (i.e. of viscosity lower than 20,000 Pa.s, see above). In characteristic manner, said method comprises:

delivering a stream of glass, said stream of glass having each of its faces free from making contact with any surface whatsoever and thus being liable to be destabilized mechanically;

treating said delivered stream of glass prior to destabilization by putting one of its two faces into contact with treatment devices or mechanisms suitable, temporarily, for supporting its weight and for accompanying its falling movement while increasing its viscosity and maintaining at least the central strip of the other one of its two faces free from any contact with any surface whatsoever;

using appropriate devices or mechanisms to act on the treated stream at a suitable distance downstream to control its travel speed and also the width and the thickness of the sheet of glass produced; and

cooling said sheet of glass that is produced.

The method may further comprise:

guiding said treated stream towards said appropriate devices or mechanisms; said guidance being provided while ensuring that at least the central strip of said face of said treated stream that has been kept free from contact with any surface whatsoever during the treatment step continues to be kept free from any such contact. This guidance step may or may not be necessary, depending on the viscosity of the stream of glass in question after treatment.

In the method of the invention:

a stream of glass is generated free from any contact;

it is taken up rapidly before mechanical destabilization, and its viscosity is increased;

the flow is controlled and cooled in order to obtain a sheet of glass having one of its faces that is free from making any contact with any surface whatsoever, at least in its central portion. The surface quality of one of the faces of the resulting sheet depends on this lack of contact.

During the first step of the method of the invention, a flow or stream of glass is thus delivered. This flow advantageously has viscosity lying in the range 5 Pa.s to 5000 Pa.s (50 poises to 50,000 poises), and very advantageously has viscosity lying in the range 10 Pa.s to 1000 Pa.s (100 poises to 10,000 poises). As mentioned in the introduction to the present specification, the method of the invention has been developed most particularly with reference to low viscosity glasses.

The delivered flow of glass has both faces free from any contact with any surface whatsoever. It is delivered in this way and falls under gravity. The height through which it can fall is naturally limited. It must be taken up before it becomes unstable. The acceptable fall height naturally depends on the glass in question. In general it does not exceed 150 millimeters (mm). Advantageously, it is less than 60 mm. Given a particular glass, the person skilled in the art is perfectly capable of optimizing this fall height, i.e. of implementing delivery of said glass.

During the second step of the method of the invention, the delivered stream of glass is treated. Before it begins to destabilize, said glass stream is taken up under conditions which naturally do not themselves give rise to destabilization, and which ensure that at least the central strip of one of the faces of the glass remains free from any contact with any surface whatsoever (the face in question remains free from any contact or, in any event, is contacted only on its margins), and which cause the viscosity of the glass to increase. Said stream of glass is treated, and at the end of treatment it is more viscous than on being delivered upstream. The glass is thus stabilized.

In a variant preferred implementation, the treatment of the delivered stream of glass comprises:

receiving said delivered stream on the surface of a roller, said roller presenting a suitable surface temperature and being set into rotation in a suitable direction and at a suitable speed to accompany the movement of said stream without any relative displacement of said stream relative to the surface of said roller;

maintaining contact between the stream and the roller without relative displacement over a significant fraction of the circumference of said roller;

said roller being associated with devices or mechanisms for controlling its surface temperature and thus the temperature of the glass in contact therewith, said roller being disposed and driven appropriately to ensure that said contact that is maintained cools the glass sufficiently to obtain the desired increase in viscosity.

In the context of this preferred variant implementation, the treated stream of glass conserves one of its faces free from any contact.

As devices or mechanisms for controlling its surface temperature, the forming roller may in particular include in its structure at least one recess within which a cooling fluid (air, water, for example) is circulated. It is also quite possible to use devices or mechanisms for controlling the surface temperature of the forming roller outside the structure of said roller. Thus, it is possible to make use of at last one strip of cooling nozzles.

At the end of the second step of the method of the invention, the treated stream advantageously presents viscosity lying in the range 10³ Pa.s to 10⁶ Pa.s (10⁴ poises to 10⁷ poises).

In any event, said stream of glass has its viscosity significantly increased.

Naturally, when a guidance stage is implemented, it must not harm the desired surface quality of the final sheet. Guidance is thus provided without there being any contact with any surface whatsoever for at least the central strip of the face of the stream in question that is kept free from any contact of this type during the preceding treatment step. Guidance is advantageously provided so that both surfaces of the stream of glass in question do not make any contact with any surface whatsoever so that the final sheets can be obtained that are free from any contact over the entire surface of one of their faces. Guidance can also be provided using contact that is strictly restricted to the margins of the sheet. Whatever the exact implementation of this guidance, the central strip of the face of the sheet that remains free from any contact during the second step of the treatment continues to remain free from any contact.

The guidance which is provided over a distance of varying length depending on the apparatus used is advantageously implemented under temperature control. It may be advantageous in some contexts to further cool the stream of glass in question so as to increase its viscosity.

Such guidance is advantageously provided by a film of gas supporting the stream of glass in question. In a preferred variant implementation, guidance is provided by two films of gas, with said stream of glass in question progressing between them. It is thus possible, advantageously, to generate air cushions beneath the stream of glass (air cushions carrying said stream), and most advantageously to generate air cushions on both sides of said stream.

In the context of such variant implementations of guidance, said guidance does not require any contact with the stream of glass.

In another variant implementation, guidance makes use of margin rollers or wheels. Such rollers or wheels act on the margins of the treated stream of glass so that the central strip of said stream remains free from any contact. Such rollers or wheels advantageously act in facing pairs on opposite sides of the stream in question.

Downstream from the zone for treating the stream of glass, suitable devices or mechanisms are caused to act on the resulting sheet of glass in conventional manner to control its travel speed and also to control its width and its thickness. Such devices or mechanisms are generally of two types: a first type acting on the margins of the sheet while it is not cooled or cooled only a little (which margins having surface contact are damaged and are subsequently eliminated); and a second type further downstream acting on the full width of the cooled and consolidated sheet.

The sheet of glass is then cooled.

The last steps of the method, driving and cooling the resulting sheet, are conventional.

The method of the invention as described above with reference to a single stream of glass is advantageously implemented in association with a second stream of glass and with the two streams of glass in question being welded together.

If only a single stream of glass is involved, the resulting sheet presents high surface quality on one face only (at least over the central strip of said one face, see above).

When two streams of glass are involved, the resulting sheet can present high surface quality on both faces (at least over the central strip of each of its two faces, see below). This is the preferred variant implementation of the method of the invention. In this context involving two streams of glass, it is also possible to use the invention to produce sheets of glass which present high surface quality on one face (at least over the central strip of said face, see below) together with a pattern or imprint on the other face.

Thus, the method of the invention as described above may further comprise:

delivering a second stream of glass compatible with the first stream; said second stream of glass having both of its faces free from contact with any surface whatsoever and thus being liable to be destabilized mechanically;

treating said second delivered stream of glass prior to destabilization in order to stabilize it mechanically and increase its viscosity;

guiding the first and second treated streams of glass towards a junction zone; said guidance of said first treated stream being provided while ensuring that at least the central strip of the face of said first treated stream that has been kept free from making contact with any surface whatsoever during the prior treatment step continues to be kept free from any such contact;

joining said first and second treated and guided streams; the streams being joined via the face of said first treated stream that has come into contact upstream with said treatment devices or mechanisms, while said other face of said first treated stream remains (quasi) free from any contact with any surface whatsoever;

it being understood that the action of devices or mechanisms suitable for controlling the travel speed and the width and the thickness of the sheet of glass that is produced is applied to said two joined-together streams.

During the first step of this variant implementation of the method of the invention, two flows or streams of glass are delivered. These flows are advantageously of viscosity lying in the range 5 Pa.s to 5000 Pa.s (50 poises to 50,000 poises), very advantageously in the range 10 Pa.s to 1000 Pa.s (100 poises to 10,000 poises). As explained in the introduction to the present specification, the method of the invention has been developed most particularly with reference to low viscosity glasses.

Said two flows of glass may optionally present the same viscosity. In any event, they are compatible, i.e. they are suitable for welding together perfectly.

Said two flows of glass may be delivered from a single source (in which case the glass of both flows is identical) or from two distinct sources (in which case the glass in each flow may be identical or different, but necessarily compatible).

The first stream of glass is delivered, treated (as described above) and then joined to the second under conditions such that one of its two faces remains (quasi) free from any contact with any surface whatsoever.

The second stream of glass is suitable for being treated, guided, and then joined to the first under conditions that can be different or identical.

Thus, its treatment may be implemented under conditions which affect the surface state of both of its faces. Said treatment of the second delivered stream of glass may thus comprise rolling, implemented with or without an imprint being transferred, and advantageously with a pattern being imprinted. It is then possible to obtain a sheet of glass presenting said pattern in one face and high surface quality on the other face. Upstream and downstream from said treatment (rolling), the second stream of glass may behave in the same manner as the first.

The treatment of the second stream of glass is advantageously implemented under conditions that affect the surface state of only one of its faces, its face that is to be stuck to the first stream of glass. This makes it possible to obtain a sheet of glass presenting high surface quality on both faces. This variant of the method of the invention which covers its best implementation is described in greater detail below in more general manner.

The method of the invention may thus comprise:

delivering two compatible streams of glass; said two delivered streams of glass each having both faces free from any contact with any surface whatsoever and thus being liable to be destabilized mechanically;

independently treating said two delivered streams prior to destabilization, by putting one of their two faces into contact with treatment devices or mechanisms suitable, temporarily, for supporting their weight and accompanying their falling movement, while increasing their respective viscosities and maintaining at least the central strip of the other one of their two faces free from contact with any surface whatsoever;

guiding both of said two treated streams towards a junction zone; said guidance being provided while ensuring that at least the central strip of the face of each of said two treated streams that is kept free from contact with any surface whatsoever during the preceding treatment step continues to be kept free from any such contact;

joining together said two treated streams via their faces that have come into contact with said treatment devices or mechanisms upstream; the other one of their faces remaining (quasi) free from any contact with any surface whatsoever;

acting on said two joined-together treated streams with devices or mechanisms suitable for controlling the travel speed and also the width and the thickness of the sheet of glass that is produced; and

cooling said sheet of glass.

This advantageous variant of the method of the invention (i.e. this variant in which the treatment of the second stream affects only the surface state of its face that is to be stuck to the first stream of glass) is described in greater detail below in its best implementation which leads to a sheet of glass having both faces presenting high surface quality.

The first step of delivering two streams or flows of glass that are compatible is already described in detail above.

Each of said two delivered flows of glass has both of its two faces completely free of any contact with any surface whatsoever. The flows are delivered in this way so as to fall freely. The height of their fall is naturally limited. They need to be taken up before they become destabilized. The height of the fall that is acceptable naturally depends on the glass(es) in question. As a general rule it does not exceed 150 mm. Advantageously it is less than 60 mm. Depending on the glass(es) in question, the person skilled in the art is well aware how to optimize the height of this fall, i.e. how to implement delivery of said glass(es).

During the second step of the method of the invention, both of said streams of glass are treated. Said two streams of glass are taken up prior to any destabilization under conditions which naturally do not themselves lead to destabilization, but which ensure that at least the central strip of one face of each stream remains free from any contact with any surface whatsoever (the face in question remains completely untouched or, in any event is touched only on its margins), and which give rise to an increase in viscosity. Said two streams of glass are treated independently of each other (it is entirely possible for them to be subjected to treatments that are completely different, but in practice, for obvious reasons, as a general rule they are subjected to treatments that are identical or at least similar), and after they have been treated, they are more viscous than they were during delivery, upstream. This stabilizes them.

Said two streams of glass generally have their respective viscosities increased to a value that is the same for both of them or to values that are relatively close. Nevertheless, in the context of the invention, it is not impossible for the two treated streams of glass to have viscosities that are relatively different. The person skilled in the art is well aware that it is quite possible to weld together glasses of viscosities that are relatively different. In other technical fields, and in particular in optical instruments, glasses are welded together in which the ratio of viscosities may have a value as high as 3 at the welding temperature.

In a preferred implementation, the treatment of one or the other and advantageously of both of said two delivered streams comprises:

receiving the (or each of said two) delivered stream(s) on the surface of a “forming” roller presenting a suitable surface temperature and being set into rotation in an appropriate speed and direction to ensure that it accompanies the movement of the stream in question without relative displacement between said stream and the surface of said roller in question;

maintaining contact between the stream and the roller without relative displacement over a significant fraction of the circumference of the roller in question;

said roller(s) being associated with devices or mechanisms for controlling surface temperature and thus temperature of the glass in contact therewith, and advantageously being fitted with such devices or mechanisms, said roller(s) being located and entrained suitably in such a manner that said contact that is maintained causes the glass to cool down sufficiently to achieve the desired increase of viscosity.

In the context of this preferred implementation, each of the treated streams of glass conserves one face each that is free from any contact.

As means, devices or mechanisms, suitable for controlling surface temperature, the structure of the forming rollers may include recesses suitable for carrying a circulating cooling fluid (air or water, for example). Furthermore, it is not impossible to devise means for controlling the surface temperature of the forming rollers located outside the structure of said rollers. Thus, at least one strip of cooling nozzles may be provided.

At the end of the second step of the method of the invention, the treated streams advantageously present viscosity lying in the range 10³ Pa.s to 10⁶ Pa.s (10⁴ poises to 10⁷ poises).

In any event, the viscosity of said streams of glass is increased significantly.

Said treated streams of glass then need to be welded together to generate the expected sheet of glass. Welding needs to be done via their faces that have been subjected to contact during the second step of the method, so that the faces of the sheet of glass that results from the welding are constituted by the outside faces of said two streams of glass that are (quasi) free of any contact.

Prior to said welding, or joining, of said streams of treated glass, each of said streams is guided towards the joining zone. This guidance stage must naturally avoid spoiling the desired surface quality of the final sheet. Guidance is provided without any contact being made with any surface whatsoever by at least the central strips of the faces of both of said two streams in question that have been kept free of any contact of this type during the preceding treatment step. Guidance is advantageously provided without either of the two faces of each of the sheets in question making contact with any surface whatsoever so that the faces of the final sheet can be obtained free from any contact over their entire area. Alternatively, guidance can be obtained while restricting contact to the margins only of each of the two sheets. Whatever the particular way in which this guidance is implemented, the central strip of the face of each of the two sheets that has remained free from contact during the second step of treatment continues to remain free from any contact.

Guidance is provided over a longer or shorter distance (depending on the apparatus used) and is advantageously implemented under temperature control. In certain contexts it can be advantageous to further cool the streams of glass in question in order to increase their viscosity. In other contexts, it can be advantageous to heat said streams of glass in preparation for welding them together.

Such guidance is advantageously provided by a film of gas supporting the stream of glass in question. In a preferred variant implementation, two films of gas are provided, with each stream of glass in question progressing between them. It is thus advantageous to generate cushions of air beneath each of the streams of glass (i.e. air cushions carrying said streams), and most advantageously to generate cushions of air on both sides of each of said streams.

In the context of such variant implementations of guidance, said guidance avoids any contact with the streams of glass.

In another variant implementation, guidance makes use of margin rollers or wheels. Such rollers or wheels act on the margins of the treated stream of glass so that the central strip of each stream remains free from any contact. Such rollers or wheels advantageously act in pairs, being disposed facing each other on opposite sides of the stream in question.

Advantageously, both streams of treated glass are guided using guidance of the same type (for example using at least one film of gas or using margin rollers or wheels), but this is not essential in any way.

The two streams of glass are generally joined together (welded together) while they are at a viscosity lying in the range 2000 Pa.s to 107 Pa.s (20,000 poises to 10⁸ poises).

Said streams of glass do not present any particular problem for being joined together. The two streams are advantageously joined together using devices or mechanisms of the same type as those used upstream of the welding zone.

Downstream from the zone where the two streams of glass are joined together, appropriate devices or mechanisms are used in conventional manner on the resulting sheet of glass to control the travel speed of said sheet and also to control its width and its thickness. In general, such means, devices or mechanisms, are of two types: a first type acting on the margins of the sheet that has not been cooled or that has been cooled relatively little (the margins contacted in this way are thus damaged and subsequently eliminated); and of a second type which takes place further downstream over the entire width of the cooled and consolidated sheet.

The sheet of glass is thus cooled.

These later steps of the method, i.e. driving and cooling of the sheet produced by joining together the two streams, are in principle and can be implemented in practice in a manner that is entirely similar to the same later steps in the prior art Fusion Draw method.

The details given above concerning the guidance and joining stages when describing the preferred implementation for obtaining a sheet of glass presenting high quality surface on both faces in the advantageous variant of the method of the invention in which the treatment step does not affect the surface state of the second face of the second stream, can be transposed to other circumstances:

to the context of the above-described variant in which the second stream of glass is rolled;

to the context of another implementation of said advantageous variant as described below; and also

to another context in which the second face of the second stream is subjected to contact during treatment.

The second and third contexts are described below.

In the advantageous variant of the method of the invention, as described above, provision can be made for transferring a pattern onto one of the two treated streams (the second stream) prior to joining said streams together. The face that is practically free from any contact during the treatment and guidance of the stream in question is marked with a pattern. Clearly this is the face that is to constitute one of the faces of the final sheet and not the face that is to be secured to the other stream of glass.

In the context of said other context, the method of the invention comprises:

delivering two compatible streams of glass; said two delivered streams of glass each having both faces free from any contact with any surface whatsoever and thus being liable to be destabilized mechanically;

treating both of said delivered streams independently prior to destabilization:

one of said two streams being treated by putting one of its two faces into contact with treatment means suitable for temporarily supporting its weight and for accompanying its falling movement while increasing its viscosity and while maintaining at least the central strip of the other one of its faces free from contact with any surface whatsoever; while the other one of said two streams is treated by putting one of its two faces into contact with treatment means suitable, temporarily, for supporting its weight and for accompanying its falling movement, while increasing its viscosity and while subjecting the other one of its two faces to the action of other devices or mechanisms which, co-operating with said treatment devices or mechanisms, serve to transfer an imprint onto said other one of its two faces;

guiding both of the two treated streams towards a junction zone; said guidance being provided while ensuring that at least the central strip of the face of the treated stream that is kept free from any contact with any surface whatsoever during the preceding treatment step continues to be kept free from any such contact, and while also, advantageously, ensuring that at least the central strip of the face of the other treated stream onto which an imprint has been transferred is also not put into contact with any surface whatsoever;

joining said two treated streams together via their faces which have come into contact with said treatment devices or mechanisms upstream; at least the other face of the treated stream which does not have an imprint remaining (quasi) free from any contact with any surface whatsoever;

acting on said joined-together treated streams by devices or mechanisms suitable for controlling the travel speed and the width and the thickness of said sheet of glass that is produced; and

cooling said sheet of glass.

In the context of this variant of the method of the invention, a pattern is transferred onto the face of one of the two streams, while the stream is being treated, which face is a priori intended to be made with a central strip that is free from any contact with any surface whatsoever. It is thus possible locally to modify the preferred implementation of the advantageous variant of the method of the invention.

The second aspect of the present invention is described below, namely apparatus for producing sheets of glass having two faces, with at least one of said faces presenting high surface quality, and advantageously both of said faces presenting high surface quality. Said apparatus is suitable for implementing the above-described method, and for implementing all of the variants of said method as described above.

The apparatus of the invention comprises, from upstream to downstream (relative to the travel direction of the stream of glass: a single stream of glass for use in a basic apparatus restricted to the means, devices or mechanisms, listed below; such basic apparatus being suitable for being associated, or indeed merely duplicated in order to process two streams that are to be welded together):

delivery means, device or mechanism, for delivering a stream of glass under conditions in which said stream of glass has both of its two faces free from any contact with any surface whatsoever;

treatment means, devices or mechanisms, for treating said delivered stream of glass, said means being suitable for being put into contact with one of its two faces and for supporting the weight of said stream temporarily while accompanying its falling movement and increasing its viscosity and while maintaining at least the central strip of the other one of its two faces free from any contact with any surface whatsoever; the relative disposition of said delivery means, devices or mechanisms, and said treatment means being compatible with the mechanical stability of said delivered stream;

devices or mechanisms located at a suitable position downstream for controlling the travel speed and also the width and the thickness of the sheet of glass that is produced; and

devices or mechanisms for cooling said sheet of glass that is produced.

Said basic apparatus may further comprise:

guidance devices or mechanisms for guiding said treated stream; said guidance devices or mechanisms acting upstream from said devices or mechanisms for controlling the travel speed, width, and thickness of the sheet of glass that is produced and performing their guidance function without involving any contact with at least the central strip of the face of the treated stream that has been kept free from any contact with any surface whatsoever by said treatment devices or mechanisms.

The means, devices or mechanisms, in question (delivery means, treatment means, guidance means, control means, and cooling means) exist in various embodiments and can be arranged in different variants.

The means, devices or mechanisms, for delivering the glass stream may consist in any conventional delivery system, for example of the isopipe or of the casting device type.

As described above, the relative disposition of the means for delivering and treating the stream of glass must be compatible with said stream retaining mechanical stability. As already specified, with reference to the method of the invention, it is necessary to limit the height of the free fall of the streams in question. Consequently, the relative disposition of the delivery means and of the treatment means is generally such that the delivered stream remains free from any contact with any surface whatsoever over a height that does not exceed 150 mm, which height is advantageously no greater than 60 mm.

Said treatment means may also exist in several variants. In a preferred variant, they comprise mainly a roller suitable for being rotated and fitted internally with means for controlling its surface temperature. Such a roller is referred to as a “forming” roller and can be made in particular out of refractory material or metal alloy, for example an alloy containing at least 15% by weight of nickel. Various diameters can be used, generally lying in the range 40 mm to 200 mm, and preferably in the range 50 mm to 120 mm. On its inside, a fluid circulation circuit is generally provided. In another variant, means can be provided outside the structure of the forming roller for controlling the surface temperature of said roller. Such means can be constituted in particular by at least one strip of cooling nozzles.

As described above, the optional guidance of the treated stream of glass is advantageously implemented by means of at least one film of gas. In this context, the means for guiding said stream of treated glass in the apparatus associated with said method advantageously comprise at least one wall along which a film of gas can be generated (most advantageously two such walls are provided, one on either side of the path followed by the flowing stream of glass, and both delivering a respective film of gas). In a first embodiment, such walls are made of a material having open pores; in a second embodiment, the walls include within their structure artificial passages for delivering gas. Upstream from such walls, whether naturally porous or made porous artificially (open pores), there are generally means for maintaining a gas (nitrogen or air, for example) under pressure.

The first above-mentioned embodiment (walls of a porous material, for example of the graphite type or of refractory material) is preferred. Porous walls having pores used for generating a film of gas have already been described in various contexts, and in particular in the following patent documents: JP-B-48 022 977; JP-A-62 283 831; U.S. Pat. No. 1,788,037; U.S. Pat. No. 3,298,808; and U.S. Pat. No. 2,733,225.

It has also been seen that guidance of the stream of treated glass can make use of margin rollers or wheels, advantageously pairs of such rollers or wheels. The apparatus of the invention can thus comprise such margin rollers or wheels as its guidance means. It has at least two such rollers or wheels each suitable for acting on one of the two margins of a given face of the stream of glass. As a general rule there are several such couples distributed along the length of said stream. Advantageously, such apparatus for guiding a stream of glass (two margin rollers or wheels or a plurality of couples of such rollers or wheels of this type acting on the bottom face of said stream) is associated with apparatus of the same type having rollers or wheels acting opposite the above-mentioned rollers or wheels on the other face (the top face) of the stream in question. The rollers or wheels placed facing each other are said to be in “pairs” so as to develop their action on opposite sides of the flowing stream of glass.

Whatever the way in which they are implemented, the guide means are advantageously suitable for controlling the temperature of the guided stream of glass. It can be advantageous, as described above, to cool said guided stream. Thus, the walls along which said stream of glass is guided may advantageously contain resistance elements or circuits for circulating fluids.

Downstream from the treatment means, and possibly also downstream from the guidance means, there are means for maintaining the travel speed, the width, and the thickness of the sheet of glass that is produced, and also means for cooling said sheet. These means are advantageously means of the same type as those used in the prior art in similar locations. Thus, for the means suitable for controlling the travel speed, width, and thickness, it is recommended to use margin wheels and/or tractor rollers, advantageously to use margin wheels on the sheet where it is not yet cooled or has cooled little, and subsequently, downstream therefrom, it is recommended to use tractor rollers on the sheet that has cooled and been consolidated.

The above-described “basic” apparatus of the invention is advantageously organized to handle two streams of glass. Thus, the apparatus of the invention advantageously further comprises:

delivery means for delivering a second stream of glass under conditions in which said second stream of glass has both of its two faces free from any contact with any surface whatsoever;

treatment means for treating said second delivered stream of glass, the treatment means being suitable for mechanically stabilizing said second delivered stream and for increasing its viscosity; the relative disposition of said delivery means and said treatment means being compatible with mechanical stability of said second delivered stream;

guidance means for guiding said second treated stream of glass towards a junction zone for joining it with a first treated and guided stream of glass;

junction means for putting said first and second treated and guided streams into contact; said first treated stream being put into contact with said second treated stream via its face that has come into contact upstream with the treatment means, its other face remaining (quasi) free from any contact with any surface whosoever;

and the means disposed at a suitable position downstream from the junction zone are suitable for controlling the travel speed and also the width and the thickness of the sheet of glass that is produced by joining together said first and second treated streams.

The means for delivering the two streams of glass in question may consist in a single feed source or in two distinct sources, in particular they may be constituted by:

a single receptacle suitable for being fed and for overflowing over two faces, such a receptacle may entirely be similar to a truncated isopipe as disclosed in U.S. Pat. Nos. 3,149,949 and 3,338,696; or

a single casting device having two open ends that are distinct and fitted with slots, the width of said slots naturally being adapted to the viscosity of the streams of glass in question; or

two isopipes, both being devices of the kind described in said U.S. Pat. Nos. 3,149,949 and 3,338,696.

The means acting on the first stream in question (the delivery means, the treatment means, the guidance means, the joining means) act under conditions such that one of its two faces remains (quasi) free from any contact with any surface whatsoever.

The means acting on the second stream in question (the delivery means, the treatment means, the guidance means, the joining means) may be identical with or different from the corresponding means acting on the first of the streams in question.

Thus, the apparatus of the invention can be symmetrical to a greater or lesser extent.

In particular, the treatment means may be identical or different. It may comprise means that are advantageously identical, for keeping at least a central strip of one of the faces of the stream in contact therewith completely free from any contact. It is then possible to obtain a sheet having high surface quality on both faces.

For the first stream, these means may comprise means of the roller type as described above, and for the second stream, means suitable for transferring a pattern onto the face that is to constitute the other face of the final sheet. Thus, the apparatus of the invention is suitable for delivering, treating, and joining together two streams of glass, and may include a laminating roller device for treating one of the two streams. The laminating roller device may advantageously be suitable for imprinting a pattern onto the appropriate face of one of said streams, which face is to constitute one of the faces of the final sheet.

Means suitable for use in dual apparatuses of the invention are described in greater detail below while describing in non-limiting manner further details concerning the variant that covers the preferred embodiment, suitable for delivering a sheet of glass in which both faces present high surface quality.

In an advantageous variant, the (dual) apparatus of the invention comprises:

delivery means for delivering two streams of glass under conditions in which each of them has both of its faces free from any contact with any surface whatsoever;

treatment means for independently treating each of said delivered streams of glass, which treatment means are suitable for being put into contact with one of the two faces of each of said two streams and for supporting the weight of each of said streams temporarily, for accompanying the falling movement of each of said streams while increasing the respective viscosities of each of said two streams and while maintaining at least the central strip of the other one of the two faces of each of said streams free from any contact with any surface whatsoever; the relative disposition of each delivery means and of said treatment means being compatible with mechanical stability of said delivered streams;

guidance means for guiding both of said treated streams towards a junction zone; said guidance means performing their function without involving any contact with at least the central strip of the face of each of said treated streams that have been kept free from any contact with any surface whatsoever by the treatment means;

junction means for putting said two treated streams into contact via their faces that have come into contact with the treatment means; their other faces remaining (quasi) free from any contact with any surface whatsoever;

means for controlling the travel speed and also the width and the thickness of the sheet of glass that is produced; and

means for cooling said sheet of glass that is produced.

Various types of means suitable for delivering two streams of glass are described above. The essential constraints on the relative disposition of said delivery means and of said treatment means are recalled.

The treatment means for each of the two streams are suitable for conserving at least the central strip of said two streams free from any contact. Said treatment means may exist in a variety of embodiments. In a preferred variant, they mainly comprise two rollers suitable for being rotated and fitted on the inside with means for controlling their surface temperature. Such rollers, referred to as “forming” rollers, can be made out of refractory material or out of a metal alloy, for example a metal alloy containing at least 15% by weight of nickel. They can have a variety of diameters, generally lying in the range 40 mm to 200 mm, and preferably in the range 50 mm to 120 mm. Inside, a fluid circulation circuit is normally provided. In another variant, means can be provided outside the structure of the forming rollers for controlling the surface temperature of said rollers. Such means may be constituted in particular by at least one strip of cooling nozzles.

As mentioned above, the treated streams of glass are advantageously guided using at least one gas film. In this context, the means for guiding said treated streams of glass in the associated apparatus of said method advantageously comprise at least one wall along which a film of gas can be generated (most advantageously, two such walls are provided on opposite sides of the path followed by the stream of glass in question). In a first embodiment, such walls are made of a material having open pores; in a second embodiment, such walls have artificial passages made in their structure for a gas. Upstream from such walls, whether naturally porous or made porous artificially (open porosity), there are generally means for maintaining a gas (nitrogen or air, for example) under pressure.

The first embodiment mentioned above (walls made of porous material, e.g. of the graphite type or of the refractory material type) is preferred. Porous walls having pores used for generating a film of gas have already been described, in various contexts, and in particular in the following patent documents: JP-B-48 022 977; JP-A-62 283 831; U.S. Pat. No. 1,788,037; U.S. Pat. No. 3,298,808; and U.S. Pat. No. 2,733,225.

It has also been shown that the treated streams of glass can be guided by means of margin rollers or wheels, advantageously by pairs of such rollers or wheels. The apparatus of the invention may thus comprise guidance means constituted by such margin rollers or wheels. It has at least two such rollers or wheels each suitable for acting on one of the two margins of the same face of the stream of glass in question. There are thus as a general rule a plurality of couples of wheels or rollers distributed along the length of said stream. Advantageously, such apparatus for guiding a stream of glass (two margin rollers or wheels or a plurality of couples of such rollers or wheels acting on the bottom face of said stream) is associated with apparatus of the same kind in which the rollers or wheels act in register on the opposite face (top face) of the stream in question. The rollers or wheels in question are referred to as being in “pairs” that are arranged to act in register with each other on opposite sides of the flowing stream of glass.

Regardless of the way in which they are embodied, the guidance means are advantageously suitable for controlling the temperature of the guided streams of glass. It can be advantageous for the guided streams to be cooled or for them to be heated. Thus, walls along which said streams of glass are guided may contain heating resistance elements or circuits for circulating fluids.

Concerning the above-described means of the apparatus of the invention that act upstream from the zone in which the two streams are joined together, these means may be identical for both streams. Nevertheless, this is not essential.

In order to join together (weld) the two streams of glass that have been treated and then guided towards their junction line, appropriate conventional means are generally disposed downstream from said junction line. Said junction means are advantageously of the same type as the guidance means located upstream. They can thus be constituted in particular by walls along which it is possible to generate a film of gas (such walls are advantageously arranged in line with the guidance walls of the same type, and may even be integral with such guidance walls) or margin rollers or wheels (acting together in couples, advantageously in pairs).

Downstream from the junction means, there are means for maintaining the travel speed, width, and thickness of the sheet of glass that has been produced, and also means for cooling said sheet. These means are advantageously means of the type used in the prior art for equivalent functions. Thus, for the means that control the travel speed, width, and thickness, it is recommended to use margin wheels and/or tractor rollers, advantageously to use margin wheels on the sheet where it has not yet cooled down or has cooled down little, followed, further downstream, by tractor rollers acting on the sheet that has cooled and been consolidated.

Such apparatus of the invention can be completely or somewhat symmetrical, at least in general design, and is suitable for generating two streams of glass, each having one face that is quasi or completely intact, and for uniting said two streams of glass via their other faces that are polluted so as to produce a sheet of glass having two faces that present high surface quality.

Nevertheless, the apparatus can be modified (as explained above this may be for satisfying a particular requirement) so as to be suitable for transferring a pattern onto one or other of said two faces that would otherwise be obtained in (quasi) intact manner.

This localized modification may be applied downstream from the means for treating the streams in question: thus, in the advantageous variant of the apparatus of the invention recommended above, the apparatus further comprises means for transferring a pattern onto one of the two treated streams in question, which means are disposed upstream from the means for joining said two treated streams together. Such means may be constituted in particular by laminating rollers.

Said localized modification may also apply in the treatment means which are provided a priori to treat one of the streams while polluting only one of its faces. In such a context, the apparatus of the invention comprises:

delivery means for delivering two streams of compatible glass under conditions in which each of said streams of glass has both of its faces free from any contact with any surface whatsoever;

treatment means for independently treating each of said two delivered streams of glass: said treatment means comprising first means suitable for being put into contact with one of the two faces of one of said two streams and for supporting the weight of said stream temporarily, accompanying its falling movement while increasing its viscosity and maintaining at least the central strip of the other one of said two faces of said stream free from any contact with any surface whatsoever; and second means suitable for being put into contact with one of the two faces of the other one of said two delivered streams and for supporting the weight of said stream temporarily, accompanying its falling movement while increasing its viscosity, and also third means suitable for co-operating with said second means for transferring an imprint onto the other one of the two faces of the other one of said two delivered streams; the relative disposition of said delivery means and said treatment means being compatible with mechanical stability of said delivered streams;

guidance means for guiding each of said two treated streams towards a junction zone; said guidance means performing their action without involving any contact with at least the central strip of the face of the treated stream that has been kept free from any contact with any surface whatsoever by the means involved in its treatment, and also, advantageously, without involving any contact by any surface whatsoever with at least the central strip of the face of the other treated stream on which said third means have acted;

junction means for putting said two treated streams into contact via their faces that have been put into contact, upstream, respectively with the first and second treatment means; said junction means ensuring that at least the other face of the treated stream which does not carry an imprint remains (quasi) free from any contact with any surface whosoever;

means for controlling the travel speed and also the width and the thickness of the sheet of glass that is produced; and

means for cooling said sheet of glass that is produced.

In consideration of the above, the person skilled in the art will have understood the advantage of the present invention.

The invention is advantageously implemented for producing sheets of glass (glass or glass ceramic), having additional layers of conductive oxides or of semiconductors applied thereto for applications in the fields of making displays or lighting. Such sheets of glass can thus be used in association with light-emitting diode technology.

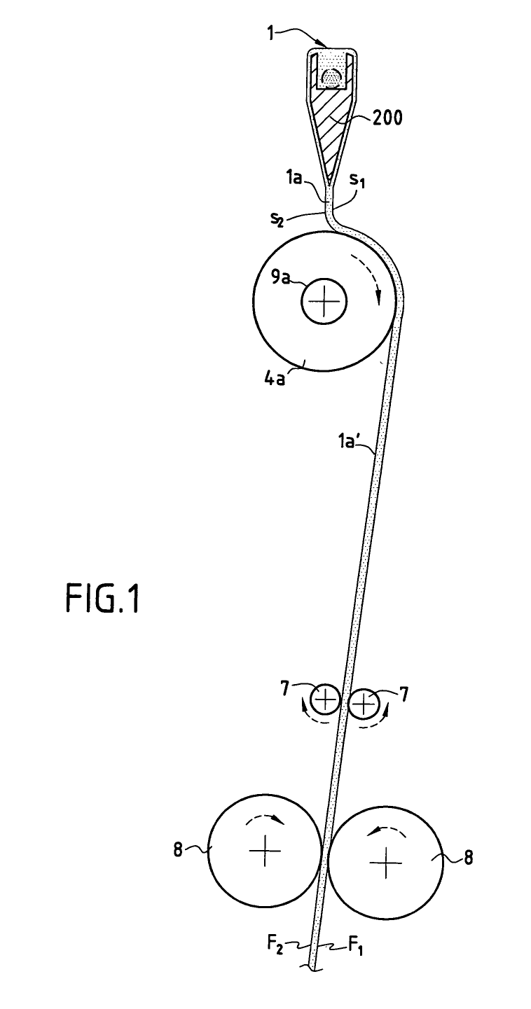

The apparatus and methods of the present invention will be further described in reference to the accompanying illustrations. FIG. 1 shows a mass 1 of molten glass. Said mass is delivered in the form of a stream 1a by a delivery device 200 of the isopipe type. Said stream of glass 1a falls freely through a small height prior to being taken up by a forming roller 4a. While falling freely, both faces s₁ and S₂ of said stream 1a are free from any contact with any surface whatsoever. On being taken up, the face S₂ of said stream 1a comes into contact with the outside surface of said forming roller 4a. The roller 4a rotates in a direction and at a speed such as to ensure that there is no relative movement between the roller and the stream in contact with said roller. Said roller 4a is used for stabilizing the stream 1a mechanically. The viscosity of said stream 1a is increased mainly by contact between the stream and the roller which implies that the stream will be cooled. This cooling is controlled by controlling the flow rate and the temperature of a cooling fluid caused to circulate through a recess 9a in said roller 4a.

The resulting sheet of glass 1a′ is entrained under drive from margin wheels 7 and tractor rollers 8. Said wheels 7 and rollers 8 are implemented in pairs. The margin rollers 7 act only on the margins while the tractor rollers 8 act further downstream on the entire width once it has consolidated.

The apparatus shown does not include means for guiding the treated stream 1a′. In this context, such guidance means are superfluous.

The sheet of glass produced in this way presents one face F₁ that has high surface quality (i.e. the face s₁ of the delivered stream 1a which is free from any contact).

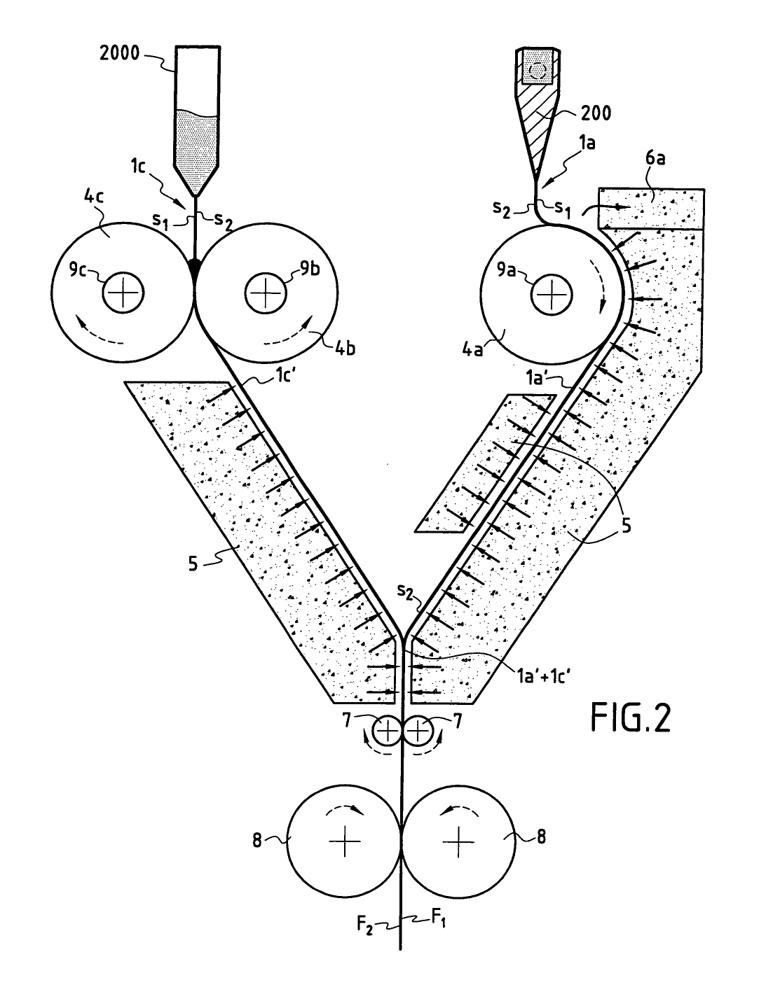

The right-hand side of FIG. 2 shows the apparatus of the invention as shown in FIG. 1 in association with means 5 for guiding the treated stream 1a′. The guidance of said treated stream 1a′ is implemented without the faces s₁ and S₂ of said treated stream 1a′ making contact with any surface whatsoever. The said treated stream 1a′ travels between two films of gas (in general two air cushions). The gas in question is delivered after passing through porous walls 5. It is exhausted from above at a wall 6a.

The guide means 5 also serve to guide a second treated stream 1c′ and to join together the two treated streams 1a′ and 1c′.

The second stream of glass 1c is delivered by delivery means 2000. It is then treated by being rolled (laminated) between rollers 4b and 4c. Within respective recesses 9b and 9c, said rollers 4b and 4c convey circulating cooling fluid.

The roller 4c is suitable for transferring an imprinted pattern onto the surface s₁ of the stream 1c.

A sheet of glass is thus produced having a face F₁ that presents high surface quality (the face s₁ of the delivered stream 1a and of the treated stream 1a′ that is free from any contact), and another face F₂ that carries a pattern (face s₁ of the rolled (laminated) stream 1c′).

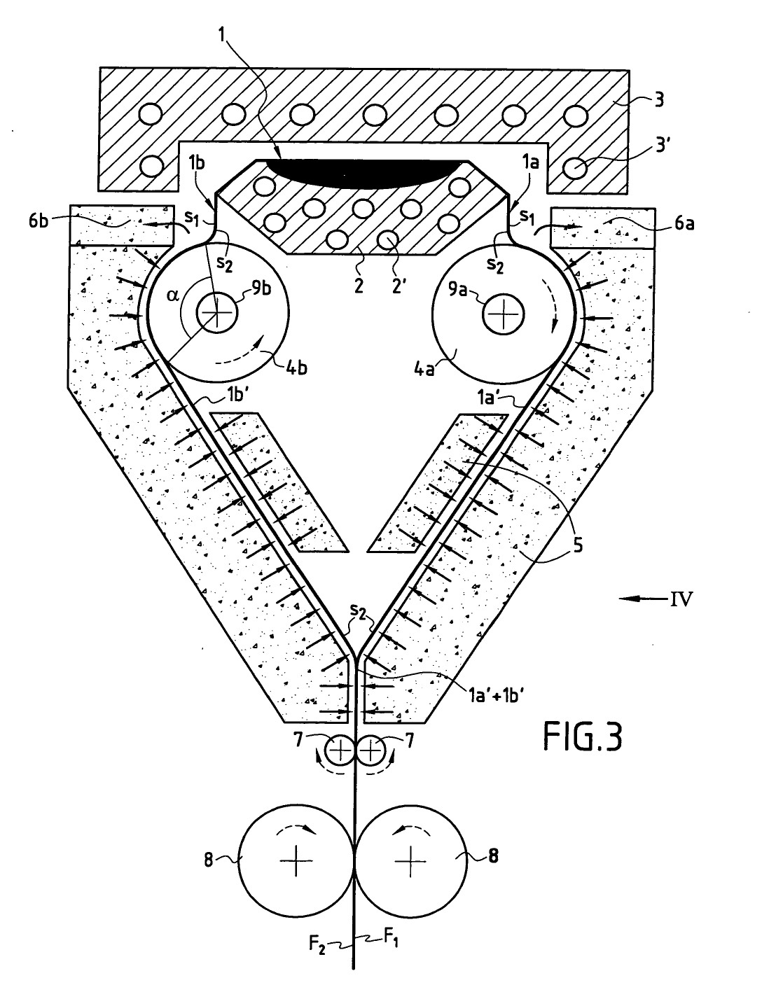

FIG. 3 shows a mass 1 of molten glass in a delivery device 2 for delivering said molten glass in the form of two streams 1a and 1b. Said streams 1a and 1b are delivered by overflowing.

Said delivery device 2 is of the truncated isopipe type. Its structure has housings 2′ suitable for receiving heating resistance elements. It is isolated from the outside by a muffler 3. The structure of said muffler 3 also contains housings 3′ suitable for receiving heating resistance elements.

The streams of glass 1a and 1b fall freely through a short distance prior to being taken up respectively by forming rollers 4a and 4b. While falling freely, both faces s₁ and s₂ of said streams 1a and 1b are free from any contact with any surface whatsoever. On being taken up, the face S₂ of each of said streams 1a and 1b comes into contact with the outside surface of the corresponding roller. The forming rollers 4a and 4b turn in opposite directions in a direction and a speed such as to ensure there is no relative movement between either roller and the stream of glass in contact therewith. The contact or “wedging” angle of the glass on the roller 4b is referenced α. On the roller 4a, the contact angle is identical. The rollers 4a and 4b are used to stabilize the freely-falling streams 4a and 4b mechanically. These rollers deliver the treated streams of glass 1a′ and 1b′. The viscosity of said streams 1a and 1b is increased, mainly by the contact between the stream and the roller which implies that the stream is cooled. This cooling is controlled by controlling the flow rate and the temperature of the cooling fluid caused to circulate in the recesses 9a and 9b of the rollers 4a and 4b.

Said treated streams 1a′ and 1b′ are then guided towards their junction zones. Guidance is implemented without the faces s₁ and S₂ of said treated streams making contact with any surface whatsoever. Said treated streams 1a′ and 1′b move between two films of gas (generally between air cushions). The gas in question is delivered after passing through porous walls 5. It is removed from the top level with walls 6a and 6b.

While the streams are being joined (implemented under the action of films of gas generated downstream of the junction line), the faces S₂ of the treated streams 1a′ and 1b′ are stuck together. The resulting sheet of glass is thus obtained with both faces (faces s₁ of the streams 1a, 1b, 1a′, and 1b′) that have been kept free from making contact with any surface whatsoever.

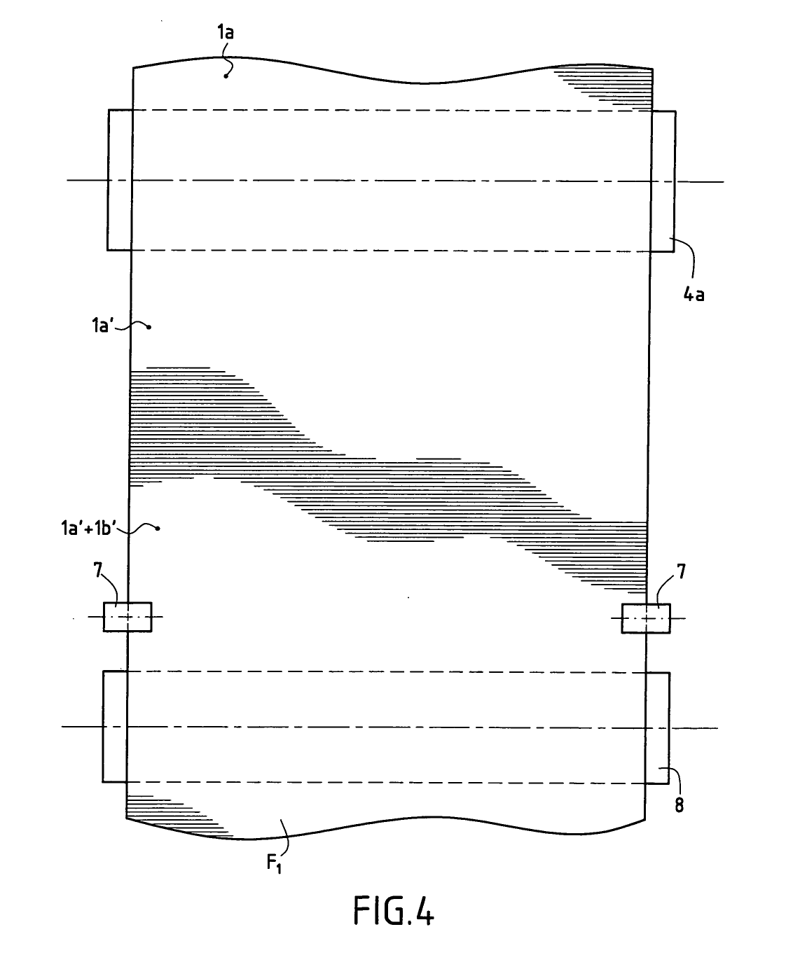

The resulting sheet of glass is driven under drive from margin wheels 7 and tractor rollers 8. Said wheels 7 and rollers 8 naturally operate in pairs. FIG. 4 shows clearly that the margin wheels 7 act only on the margins of the as yet unconsolidated sheet, which margins are recovered and recycled, whereas the tractor rollers 8 act on the entire width of the sheet once it has consolidated.

FIG. 4 shows more clearly the respective and successive actions of the forming roller 4a on the flowing stream of glass 1a, of the margin wheels 7, and of the tractor roller 8 on the stream of glass 1a′ as it flows.

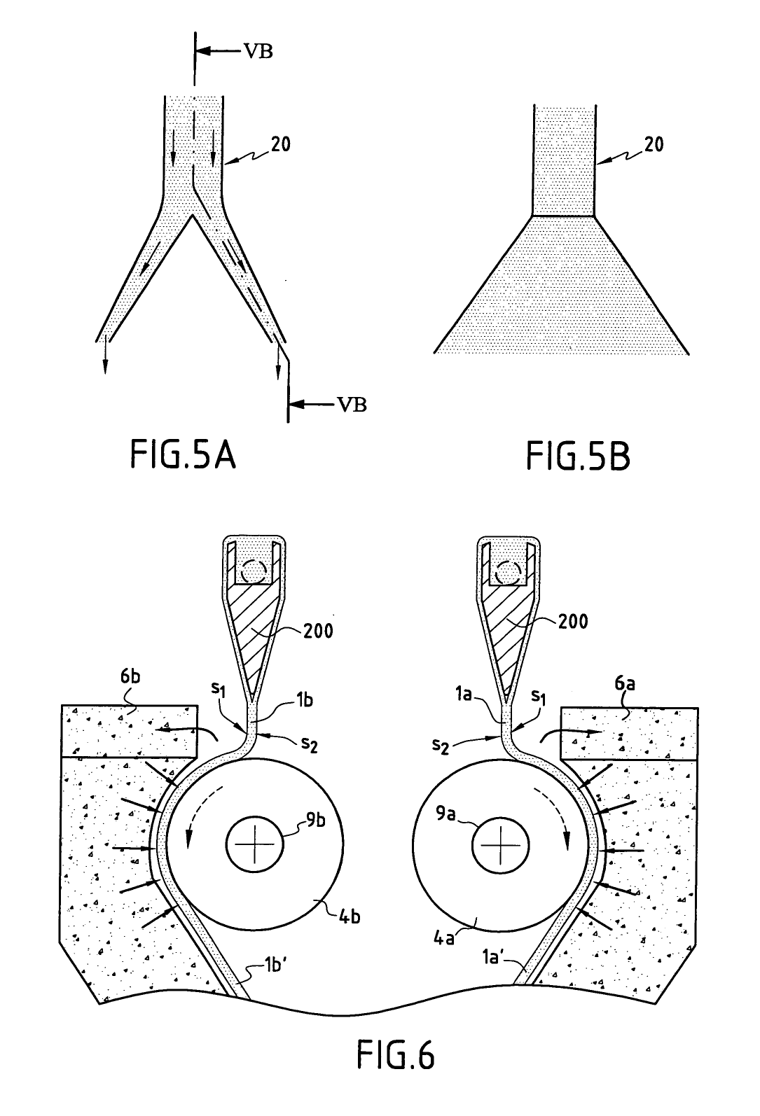

FIGS. 5A, 5B, and 6 show respective means for delivering two streams of glass that are different from the device 2 shown in FIG. 3.

The device 20 shown in FIGS. 5A and 5B is constituted by pipework having two distinct open ends fitted with slots.

The device 200 shown in FIG. 6 has two independent isopipe type entities that are identical.

The apparatuses shown in FIGS. 3 to 6 are symmetrical about a vertical axis.

As stated above, the apparatus of the invention is not necessarily symmetrical. Similarly, it does not necessarily have a vertical outlet axis.

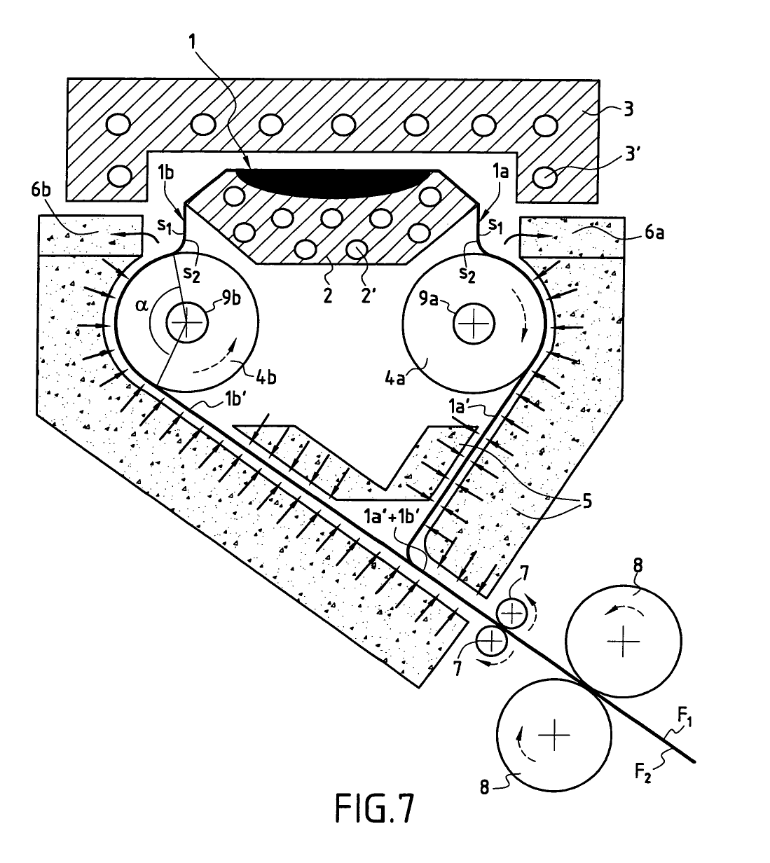

FIG. 7 shows apparatus of the invention of the same type as that shown in FIG. 3, but in which the apparatus is asymmetrical, having an outlet axis that is not vertical.

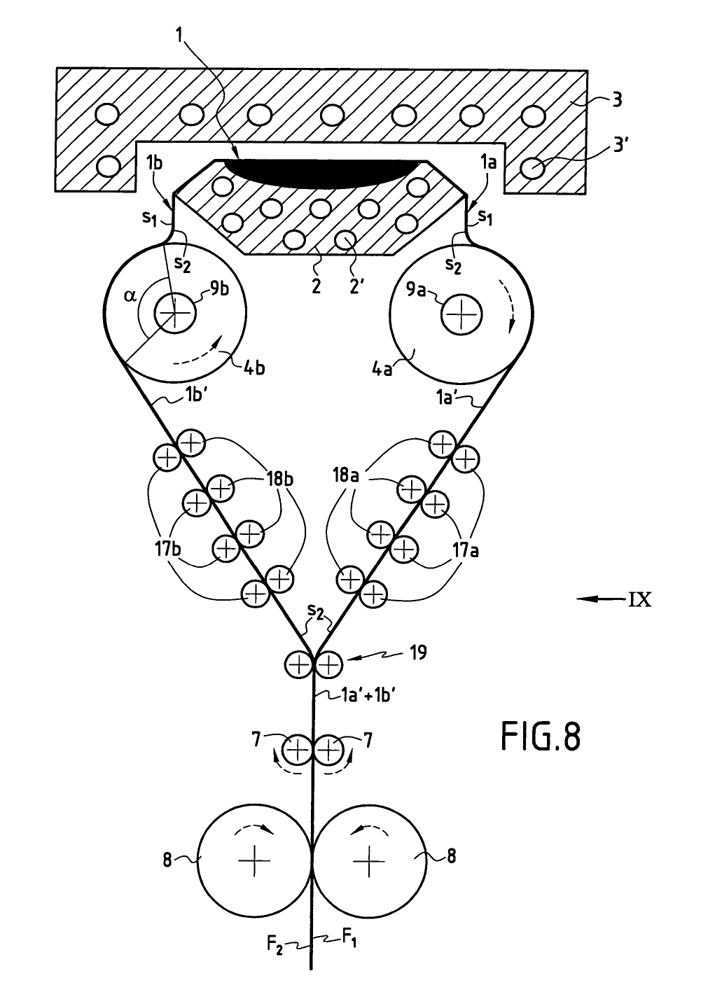

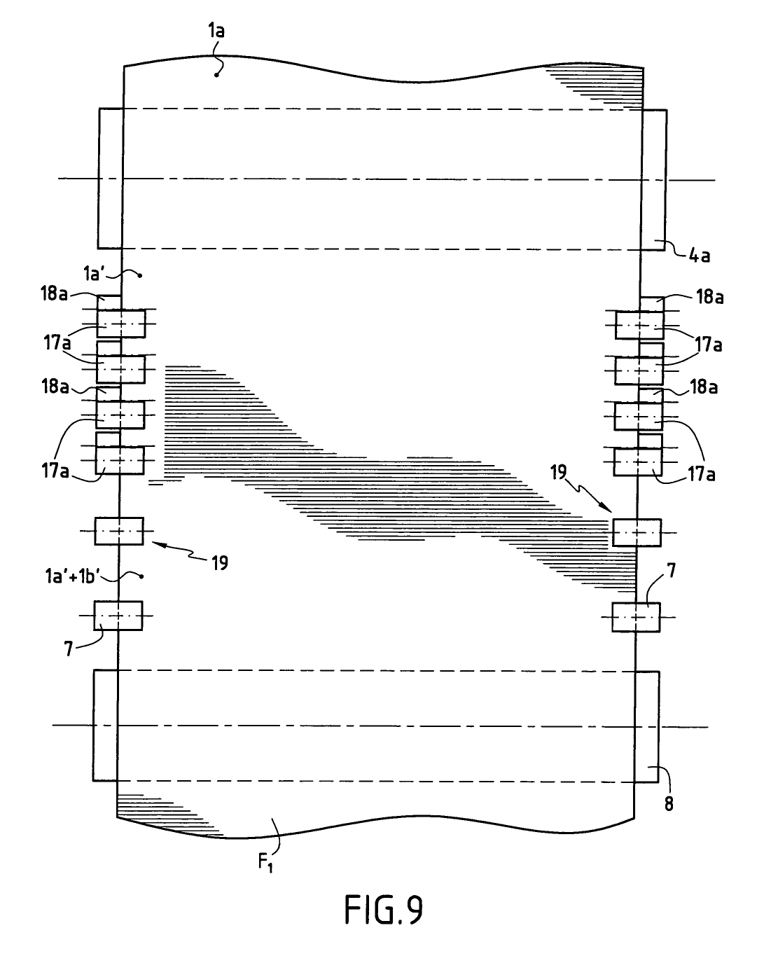

The apparatus shown in FIGS. 8 and 9 differs from that shown in FIGS. 3 to 7 in the nature of its guidance means and of its means for joining the two treated streams 1a′ and 1b′. Said guidance means (rollers) act in couples 17a; 17b on the margins of the streams of glass in question (beneath said streams), and they act in facing pairs 17a, 18a; 17b, 18b on opposite sides of each of said streams of glass. Said couples and pairs can be seen clearly in FIGS. 8 and 9.

Reference 19 shows two rollers of the same type acting to join together the two treated (and guided) streams 1a′ and 1b′.

The rollers 17a, 18a; 17b; 18b; 19 in question are narrow and act only on the margins of the sheets of glass 1a′; 1b′ that are as yet not completely consolidated (FIG. 9).

The sheets of glass produced by the apparatus of FIGS. 3 to 8 have both faces F₁ and F₂ presenting high surface quality (at least the central portion thereof has remained free from any contact).

The treatment of the streams of glass 1a and 1b is performed without their faces s₁ coming into contact with any surface whatsoever (guidance by film(s) of gas) or else with their faces s₁ making practically no contact with any surface whatsoever (guidance by rollers).

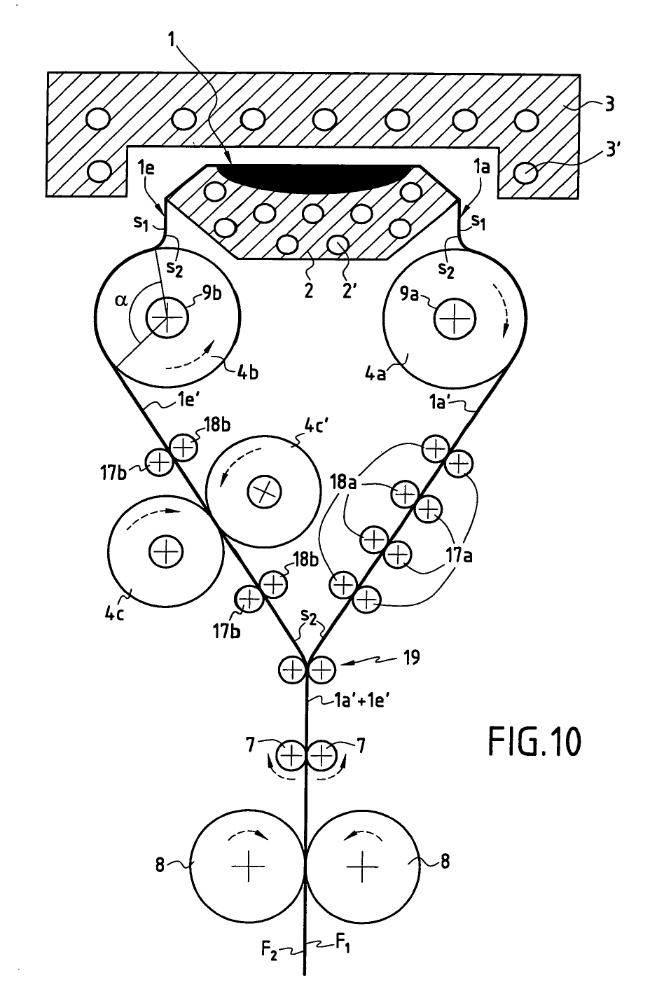

FIG. 10 shows apparatus of the invention of the same type as that shown in FIGS. 8 and 9. This apparatus comprises in addition to:

delivery means 2 for delivering two streams of glass 1a and 1e;

treatment means 4a and 4b for treating said two delivered streams of glass 1a and 1e;

respective guidance means 17a, 18a and 17b, 18b for guiding said treated streams of glass 1a′ and 1e′;

junction means 19 for joining said two treated streams of glass 1a′ and 1e′, and drive means 7 and 8 for driving the two joined-together streams 1a′+1e′, means 4c and 4c′ (means of the laminating roller type) for transmitting an imprinted pattern to the face s₁ of the treated stream 1e′.

The sheet of glass produced by the apparatus of FIG. 10 has one face F₁ (face s₁ of the treated stream 1a′ that makes practically no contact) presenting very high surface quality, and an opposite face F₂ (face s₁ of the treated stream 1e′ which has been imprinted) that presents a pattern.

It will be understood that the imprint transferring device 4c+4c′ can easily be used when required to produce sheets having a pattern on one face in apparatus of the type shown in FIGS. 8 and 9 and designed mainly for producing sheets having both faces with high surface quality.

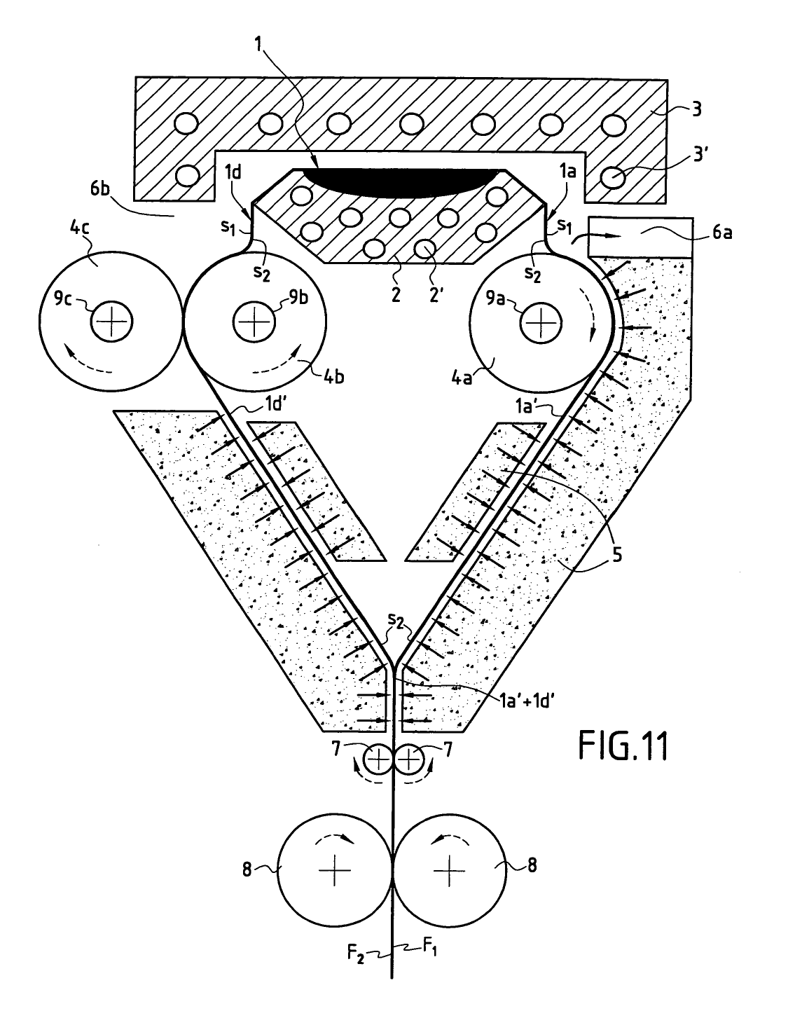

FIG. 11 shows apparatus of the invention of the same type as that shown in FIGS. 3 to 6. This apparatus comprises in addition to:

delivery means 2 for delivering two streams of glass 1a and 1d;

treatment means 4a and 4b for treating said two delivered streams of glass 1a and 1d;

guidance means 5 for guiding the two treated streams of glass 1a′ and 1d′;

junction means 5 for joining together said two treated streams of glass 1a′ and 1d′ together with drive means 7 and 8 for driving the two joined-together streams of glass 1a′+1d′;

means 4c suitable for co-operating with the treatment means 4b for treating the stream 1d so as to transfer a pattern onto the face s₁ of said stream 1d, which means 4c is constituted by a laminating type roller.

The sheet of glass produced by the apparatus of FIG. 11 has one face F₁ (face s₁ of the treated stream 1a′ that makes no contact) which presents high surface quality, while its opposite face F₂ (face s₁ of the treated stream 1d′ onto which a patter is imprinted) which presents a pattern.

The presently claimed invention is illustrated by the following example.

Glass of the alkali-lime type is delivered via two slots formed at the end of a casting tube (see FIG. 5A). Said tube is made out of platinum alloy. Each of the slots presents a width of 520 mm. The glass is delivered with viscosity of 250 poises at a temperature of about 1340° C.

Each delivered flow of glass drops through 10 mm before being received on a stainless steel forming roller having a diameter of 80 mm that is maintained at 550° C.

Each of the forming rollers is driven at a speed of 5.8 revolutions per minute (rpm). The (wetting) contact angle of the glass on each of said rollers is about 120°.

Each sheet of glass leaves the corresponding forming roller with viscosity of about 50,000 poises and at a temperature of about 950° C.

It is then guided between two cushions of nitrogen to the point where the two sheets are joined together. The nitrogen is delivered through porous graphite. A heater device formed within said graphite enables each of the two sheets to be maintained essentially isothermally as it passes between the cushions of nitrogen.

A train of margin wheels acts downstream from the junction point, followed by a train of tractor rollers (downstream from said train of margin wheels). Said trains stretch the sheet by 35%.

The zone downstream from said junction point in which said trains of margin wheels and of tractor rollers act is provided with temperature-regulated walls so that the final cooling of the sheet of glass is controlled.

This produces a sheet of glass having excellent surface quality at a speed of 2 meters per minute (m/min). Said sheet of glass is 2.6 mm thick and has a usable width of 450 mm.

This usable width of 450 mm corresponds to the initial 520 mm (width of the delivery slot) from which it has been necessary to remove a few millimeters because of the unavoidable phenomenon of attenuation and because of the two margin strips that have been worked by the margin wheels. These margin strips constitute scrap and they are conventionally recycled to the upstream end of the process.

The present invention has been described both in general and in detail by way of examples. Persons skilled in the art will understand that the invention is not limited necessarily to the specific embodiments disclosed. Modifications and variations may be made without departing from the scope of the invention as defined by the following claims or their equivalents, including equivalent components presently known, or to be developed, which may be used within the scope of the present invention. Hence, unless changes otherwise depart from the scope of the invention, the changes should be construed as being included herein.

We claim:

1. A method of producing sheets of glass having two faces (F₁, F₂) with at least one of said faces (F₁) presenting a high surface quality, the method comprising:
a) delivering a stream of glass (1a), said stream of glass (1a) having a first and second face (s₁, S₂), each face is free from making contact with any surface and thus possibly being destabilized mechanically;
b) treating said delivered stream of glass (1a) prior to destabilization by putting a first face (S₂) into contact with a treatment device or mechanism (4a) suitable, temporarily, to support the weight of said glass and for accompanying the falling movement of said glass while increasing glass viscosity and maintaining at least a central strip of said second face (s₁) free from any contact with any surface;
c) using a device or mechanism for controlling glass travel speed (7, 8) to act on the treated stream (1a′) at a suitable distance downstream; and
d) cooling said sheet of glass.

2. The method according to claim 1, wherein said method further comprises: guiding said treated stream of glass (1a′) towards said device or mechanism (7, 8); said guidance being provided while ensuring that at least said central strip of said second face (s₁) of said treated stream of glass (1′a) continues to be kept free from contact with any surface.

3. The method according to claim 1 wherein said device or mechanism for controlling glass travel speed also controls the width and the thickness of the sheet of glass produced.

4. The method according to claim 1, wherein said stream of glass (1a) is delivered with a viscosity in the range of about 5 Pa.s to about 5000 Pa.s (50 poises to 50,000 poises).

5. The method according to claim 1, wherein said stream of glass is delivered with a viscosity in the range of about 10 Pa.s to about 1000 Pa.s (100 poises to 10,000 poises).

6. The method according to claim 1, wherein said delivered stream of glass (1a) remains free from any contact with any surface whatsoever over a height that does not exceed 150 mm.

7. The method according to claim 6, wherein said delivered stream of glass (1a) remains free from any contact with any surface with a height less than 60 mm.

8. The method according to claim 1, wherein said treatment of said delivered stream (1a) comprises:
a) receiving said delivered stream of glass (1a) on the surface of a roller (4a), said roller (4a) presenting a suitable surface temperature and being set into rotation in a suitable direction and at a suitable speed to accompany the movement of said stream (1a) without any relative displacement of said stream (1a) relative to the surface of said roller (4a);
b) maintaining contact between the stream (1a) and the roller (4a) without relative displacement over a significant fraction of the circumference of said roller (4a);
wherein said roller (4a) being associated with device or mechanism (9a) for controlling its surface temperature and thus the temperature of the glass in contact therewith, said roller (4a) being disposed and driven appropriately to ensure that said contact that is maintained cools the glass sufficiently to obtain the desired increase in viscosity.

9. The method according to either claim 1 or 8, characterized in that said treated stream (1a′) at the end of said treatment presents a viscosity in the range of about 10³ Pa.s to about 10⁶ Pa.s (10⁴ poises to 10⁷ poises).

10. The method according to claim 3, wherein said guidance of said treated stream of glass (1a′) is implemented under temperature control.

11. The method according to claim 2, wherein said treated stream of glass (1a′) is guided on a film of gas, and advantageously between two films of gas.

12. The method according to claim 2, wherein margin rollers or wheels (17a, 17b) guide said treated stream of glass (1a′).

13. The method according to claim 12, wherein pairs of said rollers or wheels (17a, 18a; 17b, 18b face each other on opposite sides of said treated stream of glass (1a′).

14. The method according to any one of claims 1, wherein said method further comprises:
a) delivering a second stream of glass (1b; 1c; 1d; 1e) compatible with the first stream of glass (1a); said second stream of glass (1b; 1c; 1d; 1e) having a first and second face (s₁, S₂), both of said faces being free from contact with any surface, thus possibly being destabilized mechanically;
b) treating said second delivered stream of glass (1b; 1c; 1d; 1e) prior to destabilization in order to stabilize it mechanically and increase its viscosity;
c) guiding the first and second treated streams of glass (1a′; 1b′, 1c′, 1d′, 1e′) towards a junction zone; said guidance of said first treated stream (1a′) being provided while ensuring that at least the central strip of said second face (s₁) of said first treated stream of glass (1a′) that has been kept free from making contact with any surface continues to be kept free from any such contact;
d) joining said first and second treated and guided streams (1a′; 1b′, 1c′, 1d′, 1e′);
the streams being joined via the first face (S₂) of said first treated stream of glass (1a′) that has come into contact upstream with said treatment device or mechanism (4a), while said second face (s₁) of said first treated stream of glass (1a′) remains relatively free from any contact with any surface whatsoever; and wherein an action of said device or mechanism (7, 8) suitable for controlling the travel speed and the width and the thickness of the sheet of glass is applied to said two joined-together streams of glass (1a′+1b′; 1a′+1c′; 1a′+1d′; 1a′+1e′).

15. The method according to claim 14, wherein said treatment of said second delivered stream of glass (1c) includes rolling or laminating, implemented with or without transferring an imprint.

16. The method according to claim 15, wherein an imprint is transferred.

17. The method according to claim 14, wherein said method comprises:
delivering two compatible streams of glass (1a, 1b, or 1e); said two delivered streams of glass (1a, 1b, or 1e) each having both faces (s₁, S₂) free from any contact with any surface whatsoever and thus being liable to be destabilized mechanically;
independently treating said two delivered streams of glass (1a, 1b, or 1e) prior to destabilization, by putting a first face (S₂) in contact with said treatment device or mechanism (4a, 4b) suitable, temporarily, for supporting the weight of said glass streams and accompanying the falling movement of said glass streams, while increasing the respective viscosities of said glass streams and maintaining at least the central strip of the second face (s₁) free from contact with any surface whatsoever;
guiding both of said two treated streams of glass (1a′, 1b′, or 1e′) towards a junction zone; said guidance being provided while ensuring that at least the central strip of the second face (s₁) of each of said two treated streams of glass (1a′, 1b′, or 1e′) is kept free from contact with any surface whatsoever continues to be kept free from any such contact;
joining together said two treated streams of glass (1a′, 1b′, or 1e′) via their first faces (s₂) that have come into contact with said treatment device or mechanism (4a, 4b) upstream; the second face (s₁) remaining relatively free from any contact with any surface whatsoever;
acting on said two joined-together treated streams (1a′+1b′ or 1e′) with device or mechanism (7, 8) suitable for controlling the travel speed, width, and thickness of the sheet of glass; and
cooling said sheet of glass.

18. The method according to claim 16, characterized in that it also comprises:
transferring an imprint onto one (1e′) of said two treated streams of glass (1a′, 1e′) prior to joining together said two treated streams (1a′, 1e′).

19. The method according to claim 14, characterized in that it comprises:
delivering two compatible streams of glass (1a, 1d); said two delivered streams of glass (1a, 1d) each having a first and a second face (s₁, s₂) free from any contact with any surface whatsoever and thus being liable to be destabilized mechanically;
treating both of said delivered streams (1a, 1d) independently prior to destabilization: a first stream (1a) of said two streams of glass (1a, 1b) being treated by putting a first face (S₂) of its two faces (s₁, S₂) into contact with treatment device or mechanism (4a) suitable for temporarily supporting its weight and for accompanying its falling movement while increasing its viscosity and while maintaining at least the central strip of the second face (s₁) free from contact with any surface whatsoever; while,
the second stream (1d) of said two streams (1a, 1d) is treated by putting a first (S₂) of its two faces (s₁, s₂) into contact with a treatment device or mechanism (4d) suitable, temporarily, for supporting the weight of said glass stream and for accompanying the falling movement of said glass stream, while increasing viscosity of the glass stream and while subjecting the second face (s₁) of its two faces (s₁, S₂) to an action of other device or mechanism (4c) which, co-operating with said treatment device or mechanism (4b), serves to transfer an imprint onto said second face (s₁);
guiding both of the two treated streams of glass (1a′, 1d′) towards a junction zone; said guidance being provided while ensuring that at least the central strip of the second face (s) of the first treated stream of glass (1a′) continues to be kept free from any such contact, and while ensuring that at least the central strip of the second face (s₁) of the second treated stream of glass (1d′) onto which an imprint has been transferred is also not put into contact with any surface whatsoever;
joining said two treated streams of glass (1a′, 1d′) together via their respective first faces (S₂) which have come into contact with said treatment device or mechanism (4a, 4b) upstream; at least the second face (s₁) of the first treated stream (1a′) which does not have an imprint remaining relatively free from any contact with any surface whatsoever;
acting on said joined-together treated streams of glass (1a′+1d′) by device or mechanism (7, 8) suitable for controlling the travel speed, width, and thickness of said sheet of glass that is produced; and
cooling said sheet of glass.

20. The method according claim 14, wherein said two sheets of glass (1a, 1b; 1a, 1c; 1a, 1d; 1a, 1e) are delivered either from a single source (2; 20) or from two distinct sources (200, 200; 200, 2000).

21. An apparatus for producing sheets of glass having two faces (F₁, F₂), at least one of said faces (F₁) presents a high-surface quality, the apparatus, from upstream to downstream, comprises:
a deliverer (2; 20; 200) for delivering a stream of glass (1a) under conditions in which said stream of glass (1a) has both of its two faces (s₁, s₂) free from any contact with any surface whatsoever;
a treatment device (4a) for treating said delivered stream of glass (1a), said device or mechanism (4a) being suitable for being put into contact with one (S₂) of its two faces (s₁, S₂) and for supporting the weight of said stream (1a) temporarily while accompanying its falling movement and increasing its viscosity and while maintaining at least the central strip of the other one (s₁) of its two faces (s₁, S₂) free from any contact with any surface whatsoever;
the relative disposition of said delivery device or mechanism (2; 20; 200) and said treatment device or mechanism (4a) being compatible with the mechanical stability of said delivered stream (1a);
a controller (7, 8) located at a suitable position downstream for controlling the travel speed, width, and thickness of the resultant sheet of glass; and
a cooler for cooling said sheet of glass that is produced.

22. The apparatus according to claim 21, wherein said apparatus further comprises:
a guider (5; 17a, 18a) for guiding said treated stream (1a′); said guider (5; 17a, 18a) acting upstream from said contoller (7, 8) for controlling the travel speed, width, and thickness of the sheet of glass and performing its guidance function without involving any contact with at least the central strip of a face (s₁) of the treated stream of glass (1a′) that has been kept free from any contact with any surface whatsoever by said treatment device (4a).

23. The apparatus according to claim 21, wherein the relative disposition of the deliverer (2; 20; 200) and of the treatment device (4a) is such that the delivered stream of glass (1a) remains free from any contact with any surface whatsoever over a height that does not exceed 150 mm.

24. The apparatus according to claim 23, wherein the relative disposition of the deliverer (2; 20; 200) and of the treatment device (4a) is such that the delivered stream of glass (1a) remains free from any contact with any surface whatsoever, of a height less than 60 mm.

25. The apparatus according to claim 21, wherein said treatment device (4a) for treating said delivered stream of glass (1a) comprises a roller (4a) suitable for being driven in rotation and associated with said controller for controlling surface temperature of glass stream.

26. The apparatus according to claim 25, wherein said treatment device being fitted internally with said controller (9a).

27. The apparatus according claim 21, wherein said guider comprises walls (5) along which a film of gas can be generated.

28. The apparatus according to any one of claims 20 to 23, characterized in that said guidance device or mechanism comprise margin rollers or wheels (17a, 17b) and advantageously pairs of such rollers or wheels (17a, 18a; 17b, 18b); the rollers or wheels of each of said pairs being arranged facing each other on opposite sides of the path along which the treated stream of glass (1a′) flows.

29. The apparatus according to any one of claims 20 to 23, characterized in that said guidance device or mechanism (5) are suitable for controlling the temperature of the treated and guided stream (1a′).

30. The apparatus according to any one of claims 19 to 29, characterized in that said device or mechanism for controlling the travel speed and also the width and the thickness of the sheet of glass that is produced comprise margin wheels (7) and/or tractor rollers (8), advantageously margin wheels (7) followed by tractor rollers (8) further downstream.

31. The apparatus according to any one of claims 20 to 30, characterized in that it further comprises:
delivery device or mechanism (2; 20; 200; 2000) for delivering a second stream of glass (1b; 1c; 1d; 1e) under conditions in which said second stream of glass (1b; 1c; 1d; 1e) has both of its two faces (s₁, s₂) free from any contact with any surface whatsoever;
treatment device or mechanism (4b; 4b+4c) for treating said second delivered stream of glass (1b; 1c; 1d; 1e), the treatment device or mechanism (4b; 4b+4c) being suitable for mechanically stabilizing said second delivered stream (1b; 1c; 1d; 1e) and for increasing its viscosity;
the relative disposition of said delivery device or mechanism (2; 20; 200; 2000) and said treatment device or mechanism (4b; 4b+4c) being compatible with mechanical stability of said second delivered stream (1b; 1c; 1d; 1e);
guidance device or mechanism (5; 17b, 18b) for guiding said second treated stream of glass (1b′; 1c′; 1d′; 1e′) towards a junction zone for joining it (1b′; 1c′; 1d′; 1e′) with a first treated and guided stream of glass (1a′);
junction device or mechanism (5; 19) for putting said first and second treated and guided streams (1a′, 1b′; 1a′, 1c′; 1a′, 1d′; 1a′, 1e′) into contact; said first treated stream (1a′) being put into contact with said second treated stream (1b′; 1c′; 1d′; 1e′) via its face (S₂) that has come into contact upstream with the treatment device or mechanism (4a), its other face (s₁) remaining (quasi) free from any contact with any surface whosoever; and
in that the device or mechanism (7; 8) disposed at a suitable position downstream from the junction zone are suitable for controlling the travel speed and also the width and the thickness of the sheet of glass that is produced by joining together said first and second treated streams (1a′; 1b′; 1c′; 1d′; 1e′).

32. The apparatus according to claim 31, characterized in that said device or mechanism for treating said second delivered stream of glass (1c) comprise a rolling (laminating) device (4b+4c), advantageously suitable for transferring an imprint to the glass.

33. The apparatus according to claim 31, characterized in that it comprises, from upstream to downstream:
delivery device or mechanism (2; 20; 200) for delivering two streams of glass (1a, 1b, or 1e) under conditions in which each of them has both of its faces (s₁, s₂) free from any contact with any surface whatsoever;
treatment device or mechanism (4a, 4b) for independently treating each of said delivered streams of glass (1a, 1b, or 1e), which treatment device or mechanism (4a, 4b) are suitable for being put into contact with one of the two faces (S₂) of each of said two streams (1a, 1b, or 1e) and for supporting the weight of each of said streams (1a, 1b, or 1e) temporarily, for accompanying the falling movement of each of said streams (1a, 1b, or 1e) while increasing the respective viscosities of each of said two streams (1a, 1b, or 1e) and while maintaining at least the central strip of the other one (s₁) of the two faces of each of said streams (1a, 1b, or 1e) free from any contact with any surface whatsoever;
the relative disposition of each delivery device or mechanism (2; 20; 200) and of said treatment device or mechanism (4a, 4b) being compatible with mechanical stability of said delivered streams (1a, 1b, or 1e);
guidance device or mechanism (5; 17a, 17b) for guiding both of said treated streams (1a′, 1b′, or 1e′) towards a junction zone; said guidance device or mechanism (5; 17a, 17b) performing their function without involving any contact with at least the central strip of the face (s₁) of each of said treated streams (1a′, 1b′, or 1e′) that have been kept free from any contact with any surface whatsoever by the treatment device or mechanism (4a, 4b);
junction device or mechanism (5; 19) for putting said two treated streams (1a′, 1b′, or 1e′) into contact via their faces (S₂) that have come into contact with the treatment device or mechanism (4a, 4b); their other faces (s₁) remaining (quasi) free from any contact with any surface whatsoever;
device or mechanism (7, 8) for controlling the travel speed and also the width and the thickness of the sheet of glass that is produced; and
device or mechanism for cooling said sheet of glass that is produced.

34. The apparatus according to claim 33, characterized in that it further comprises:
device or mechanism (4c+4c′) for transferring an imprint onto one (1e′) of said two treated streams (1a′, 1e′), said device or mechanism being disposed upstream from the junction device or mechanism (19) for joining together said two treated streams (1a′, 1e′).

35. The apparatus according to claim 31, characterized in that it comprises:
delivery device or mechanism (2) for delivering two streams (1a, 1d) of compatible glass under conditions in which each of said streams of glass (1a, 1d) has both of its faces (S₁ S₂) free from any contact with any surface whatsoever;
treatment device or mechanism for independently treating each of said two delivered streams of glass (1a, 1d): said treatment device or mechanism comprising first device or mechanism (4a) suitable for being put into contact with one (s₂) of the two faces (S₁, S₂) of one (1a) of said two streams (1a, 1d) and for supporting the weight of said stream (1a) temporarily, accompanying its falling movement while increasing its viscosity and maintaining at least the central strip of the other one (s₁) of said two faces (S₁ S₂) of said stream (1a) free from any contact with any surface whatsoever; and
second device or mechanism (4b) suitable for being put into contact with one (s₂) of the two faces (s S₂) of the other one (1d) of said two delivered streams (1a, 1d) and for supporting the weight of said stream (1d) temporarily, accompanying its falling movement while increasing its viscosity, and also third device or mechanism (4c) suitable for co-operating with said second device or mechanism (4b) for transferring an imprint onto the other one (s₁) of the two faces (s₁, s₂) of the other one (1d) of said two delivered streams (1a, 1d);
the relative disposition of said delivery device or mechanism (2) and said treatment device or mechanism (4a, 4b+4c) being compatible with mechanical stability of said delivered streams (1a, 1d);
guidance device or mechanism (5) for guiding each of said two treated streams (1a′, 1d′) towards a junction zone; said guidance device or mechanism (5) performing their action without involving any contact with at least the central strip of the face (s₁) of the treated stream (1a′) that has been kept free from any contact with any surface whatsoever by the device or mechanism (4a) involved in its treatment, and also, advantageously, without involving any contact by any surface whatsoever with at least the central strip of the face (s₁) of the other treated stream (1d′) on which said third device or mechanism (4c) have acted in contact;
junction device or mechanism (5) for putting said two treated streams (1a′, 1d′) into contact via their faces (s₂) that have been put into contact, upstream, respectively with the first and second treatment device or mechanism (4a, 4b); said junction device or mechanism (5) ensuring that at least the other face (s₁) of the treated stream (1a′) which does not carry an imprint remains (quasi) free from any contact with any surface whosoever;
device or mechanism (7, 8) for controlling the travel speed and also the width and the thickness of the sheet of glass that is produced; and
device or mechanism for cooling said sheet of glass that is produced.

36. The apparatus according to any one of claims 31 to 35, characterized in that said delivery device or mechanism (200; 2; 20; 2000) for delivering said two streams of glass (1a, 1b; 1a, 1c; 1a, 1d; 1a, 1e) are constituted by a single glass feed source (2; 20) or by two distinct sources of glass (200, 2000).

37. The apparatus according to any one of claims 31 to 36, characterized in that said delivery device or mechanism (200; 2; 20) for delivering said two streams of glass are selected from:
a receptacle (2) suitable for being fed and for overflowing over two of its faces;
a casting device (20) having two distinct open ends fitted with slots; and
two isopipes (200).
